(19) United States
(12) Patent Application Publication
(10) Pub. No.: US 2007/0254268 A1
(43) Pub. Date: Nov. 1, 2007

(54) Mobile information input/output apparatus and versatile braille output apparatus

(75) Inventors: Kazufumi Adachi, Tokyo (JP); Masaaki Nakai, Tokyo (JP); Tomo Nakano, Tokyo (JP); Hiroshi Katayose, Tokyo (JP); Takashi Yamada, Tokyo (JP)

Correspondence Address: NIXON & VANDERHYE, PC, 901 NORTH GLEBE ROAD, 11TH FLOOR, ARLINGTON, VA, 22203, US

(73) Assignees: Pioneer Corporation, Tokyo (JP); Pioneer Solutions Corporation, Tokyo (JP)

(21) Appl. No.: 11/790,684

(22) Filed: Apr. 26, 2007

(30) Foreign Application Priority Data
Apr. 26, 2006 (JP) 2006-122678

(51) Int. Cl. G09B 21/00

(52) U.S. Cl. 434/112

(57) ABSTRACT

A basic control process is performed on a mobile phone. From the basic control process, various processes are branched and performed, such as a normal standby process, unread mail reading standby process, and Braille pattern data generation process. In each of the processes, each of the Braille pins of a Braille display device provided for the mobile phone is raised, as occasion demands, by drive-control performed by a Braille driving device, and for example, the content of an unread mail, the content of a creating email, and a phone number in a phone call or the like on the mobile phone are displayed as a Braille pattern. The raising direction of the Braille pins is set on the rear surface different from the operation surface of the mobile phone. Thus, while holding the mobile phone in one hand, a user can perform the operation related to the phone call or email and can quickly and accurately perceive or sense various text information displayed in Braille.

### BACKGROUND OF THE INVENTION

1. Field of the Invention

The present invention relates to a mobile information input/output apparatus, such as, e.g. a mobile phone, and a versatile Braille output apparatus which can be used for electronic equipment including the portable information input/output apparatus.

2. Description of the Related Art

As this type of apparatus, there is proposed an apparatus aimed at the visually impaired (e.g. refer to Japanese Patent Application Laid Open NO. 2002-344608). According to the Braille mobile terminal or PDA (Personal Digital Assistance) disclosed in Japanese Patent Application Laid Open NO. 2002-344608 (hereinafter referred to as a “first conventional technology”), it is provided, instead of a display device of a mobile phone, with a Braille conversion device and a Braille display device, and it is adapted to update Braille information expressed on the Braille display device at arbitral time intervals. Thus, even the visually impaired can operate the mobile phone, and can read characters of incoming emails or the like in Braille.

Moreover, there is also proposed a Braille printer built-in mobile phone (hereinafter referred to as a second conventional technology), in which a processing device for converting information data, such as audio information and text information, received by the mobile phone to a Braille pattern, a small printer capable of outputting the Braille pattern, and a sheet capable of forming the Braille pattern are built in, by which the visually impaired and the visually and hearing impaired can use data communication by the mobile phone, about as conveniently as the unimpaired can (e.g. refer to Japanese Patent Application Laid Open NO. 2002-137145).

For example, when the visually impaired use electronic equipment, such as a mobile phone, using Braille can be considered necessary; however, in the first conventional technology, for example, an operation for performing the original functions of the electronic equipment and an operation for reading Braille displayed on the Braille display device must be performed with different hands. Thus, it is far from practical in the point that this forces the visually impaired to use the both hands.

Moreover, in the second conventional technology, the text information needs to be once outputted via the Braille printer, so that the operability is half sacrificed. Moreover, considering that the content of the text information is actually outputted via the Braille printer, the confidentiality of the text information is hardly ensured.

Moreover, as a different method from the above-mentioned first and second conventional technologies, for example, if the content of incoming emails or the like is outputted as audio information, the confidentiality of the text information is sort of completely ignored, and this likely causes an unavoidable problem of invasion of privacy.

Namely, with regard to the electronic equipment, such as a mobile phone, the conventional technologies have such a technical problem that the visually impaired can hardly efficiently and effectively obtain the information that the unimpaired can confirm by vision.

### SUMMARY OF THE INVENTION

It is therefore an object of the present invention to provide a mobile information input/output apparatus and a versatile Braille output apparatus which can improve the operability in providing information in Braille for the visually impaired.

### <Mobile Information Input/Output Apparatus>

The above object of the present invention can be achieved by a mobile information input/output apparatus provided with: a case which can be at least carried; an operating device which is disposed to expose at least one portion including an operation surface on a front side of the case and which can perform an operation of indicating that at least one portion of functions is to be performed, the functions being set in advance with regard to input/output of a predetermined types of information; a function performing device for performing a function corresponding to the input out of the functions set in advance; a Braille displaying device including a plurality of unit Braille blocks, which can emerge and which are arranged at predetermined intervals to each other, the Braille displaying device capable of displaying a plurality of Braille patterns in accordance with an emerging state of each of the unit Braille blocks, a perceptive point for perceiving the displayed Braille patterns being set on a different side from the front side of the case; a Braille pattern data generating device for generating Braille pattern data related to the Braille pattern corresponding to the performed function; and a controlling device for controlling the emerging state of each of the unit Braille blocks so that the Braille pattern corresponding to the performed function is displayed by the Braille displaying device as at least one portion of the plurality of Braille patterns, on the basis of the generated Braille pattern data.

The information input/output apparatus of the present invention can adopt various aspects, such as, e.g., a simplified phone, like a mobile phone and a PHS (Personal Handyphone System) or the like, a PDA (Personal Digital Assistance, and an electronic notebook.

In the present invention, the “case” has portability to the extent that it can be at least carried. The “case” defines the exterior shape of the mobile information input/output apparatus, and it in effect includes an object which can be held or grasped by a hand of a user who is the visually and hearing impaired. The material, shape, and mechanical strength thereof are not limited at all.

The mobile information input/output apparatus in the present invention is provided with the operating device which can adopt various forms, such as, e.g., a key matrix, button switches, and a key board, and which is disposed so that at least one portion including the operation surface thereof is exposed on the front side of the case. The “front side” herein is a term used to define a positional relationship of the case, and it is not necessarily limited to the front side in a practical sense.

At least one portion of the functions set in advance with regard to the input/output of the predetermined types of information is assigned to the operating device. The operating device is adapted to perform the operation of promoting the performance of the functions, such as, e.g., pushing down or pressing. The “predetermined types of information” herein in effect includes information whose significance is to be transmitted to a user, such as various text information, like an email, functional information as for the functions of the mobile information input/output apparatus, and status information as for the state of the mobile information input/output apparatus. The “input/output” of the predetermined types of information in effect includes transmitting the various information to a user (i.e. one example of the output), a user's typing sentences of an email to be transmitted to a third party (i.e. one example of the input), or the like.

Therefore, the functions as for the input/output of the information widely include, for example, creation, transmission, reception or display of an email, notification of whether or not there is a missed call, notification of a received phone number, notification of whether or not there is an email in an unread state (hereinafter referred to as an “unread mail”, as occasion demands), and the like.

The various functions are performed by the function performing device which includes, if necessary, various apparatuses, such as, e.g. various processors, like a CPU (Central Processing Unit) or MPU (Micro Processing Unit) or the like, various electronic control units, a computer system, vibrator, or audio output apparatus.

The “input” herein includes the above-mentioned operation of the operating device, and further includes a command signal or the like which is generated and supplied without an artificial operation performed by a user or the like, if some condition is satisfied, or for some external reasons. The function performing device performs the function corresponding to the input, out of the functions set in advance, in accordance with such input. The function performing device performs, at each time, various functions, such as creating sentences related to an email, displaying the sentences related to the email, or automatically storing data about a missed call if receiving in user's absence, in accordance with the operation of the operating device.

If such various functions are set, the Braille pattern data is generated by the Braille pattern data generating device, in synchronization with or before the performance of the various functions, or a certain or uncertain time later, wherein the Braille pattern data generating device can adopt various forms, such as various processors, like a CPU or MPU, various electronic control units or a computer system.

The “Braille pattern data” herein is a concept including the data related to the Braille pattern corresponding to the performed function, and it can in effect adopt various forms, such as, e.g., image data corresponding to the Braille pattern, data for specifying or identifying the performed function, or various driving data for realizing the Braille display actually corresponding to the Braille pattern. For example, the Braille pattern data may be data for specifying various characters, such as “1” and “ [symbol] ”, inputted through the operating device, or notification data for notifying a missed call.

On the other hand, the mobile information input/output apparatus of the present invention is provided with the Braille displaying device including the plurality of unit Braille blocks, which can emerge and which are arranged at predetermined intervals to each other, the Braille displaying device capable of displaying the plurality of Braille patterns in accordance with the emerging state of each of the unit Braille blocks.

The “unit Braille blocks” are one or a plurality of blocks which can function as at least six dots (points) constituting Braille. The correspondence about what kind of dot is represented by the unit Braille block may be fixed in advance or may be set variable. If it is variable, the correspondence may be determined in accordance with a display mode individually and specifically set at each time.

Moreover, in view of the performance required for the Braille displaying device, the expression “which can emerge” is namely a concept including such a situation that if a user touches or presses the blocks with a certain degrees of power, unevenness can be generated to the extent that the user can perceive or sense it as Braille. For example, with regard to the emerging aspect, three-dimensional (i.e. spatial) unevenness may be generated by raising or lowering cylinder or columnar pins. Alternatively, for example, a voltage applied to an electrorheological fluid may be selectively changed to solidify a portion corresponding to the Braille pattern, by which a user perceives it by the sense of touch as if there were unevenness. In the latter case, the unit Braille block may be represented by the shape of an electrode.

According to the mobile information input/output apparatus of the present invention, upon its operation, the controlling device controls the emerging state of each of the unit Braille blocks so that the Braille pattern corresponding to the performed function is displayed by the Braille displaying device, on the basis of the generated Braille pattern data, through the control of a mechanical, electrical, physical, or mechanistic driving system, motor, actuator, switch for controlling an applied voltage, spring, electromagnet, or the like, wherein the controlling device can adopt various forms, such as various processors, like a CPU or MPU, various electronic control units or a computer system. Therefore, a user can perceive, from the Braille pattern displayed by the Braille displaying device, for example, which function is performed by the function performing device, and more specifically, which key is pressed by the user when creating an email, or what sentences are written in an incoming email, or the like.

Here, particularly, if operating the mobile information input/output apparatus, a user highly likely operates the operating device. Moreover, if operating the operating device, with the case holding in the hand, generally, the user highly likely uses a thumb. On the other hand, when trying to perceive the Braille pattern displayed on the Braille displaying device, a trained user usually does not consider which finger is used to perceive the Braille pattern.

However, when a user tries to perceive the Braille pattern while the operating device is operated, if the Braille displaying device is provided instead of a displaying apparatus, such as a liquid crystal display, the user tends to have difficulty in holding the mobile information input/output apparatus in one hand. If it is prioritized to hold it in one hand, naturally, it is hard to operate the operating device or perform the perceive operation of the Braille pattern. Moreover, if the operation with both hands is required, we must say that it lacks consideration for the visually impaired. Namely, in order to perform truly efficient and effective information transmission to the visually impaired, an important factor is the relative positional relationship between the operating device and at least the point related to the Braille perception on the Braille displaying device.

Thus, on the mobile information input/output apparatus of the present invention, the perceptive point for perceiving the displayed Braille patterns is set on the different side from the front side of the case (i.e. the side where the operation surface of the operating device is exposed). Incidentally, the front side of the case defines the positional relationship of the case, as described above, and it merely indicates the side on which the operation surface of the operating device is set. However, if the perceptive point is set at least on the different side from the front side, a user can operate the operating device with the thumb and also touch the perceptive point with another finger, while holding the case in one hand. Therefore, a user as the visually impaired can use the mobile information input/output apparatus in one hand in the same manner as the unimpaired do, and can receive the function's effects. Namely, according to the mobile information input/output apparatus of the present invention, it is possible to remarkably improve the operability in providing the information for the visually impaired.

Incidentally, if the case has a certain degree of columnar, plate-like, or similar shape, the front side and the different side can be clearly defined. However, if the case has a curved shape, the judgment tends to be obscure. However, considering the above-mentioned concept, namely, the both sides may diverge from each other to the extent that the operation of the operating device and the perceptive operation of the Braille displaying device can be performed simultaneously and without practical difficulty. Moreover considering that the case can be carried, in the case where such a condition is satisfied, the both sides may be located on different sides from each other. Moreover, even if the case has a continuous curved structure, normally, a user faces only its one portion during its actual use, and in such a sense, a portion which does not faces a user can be the “different side” in a narrow sense.

Incidentally, with regard to the emerging state of the unit Braille blocks, all the unit Braille block may be controlled simultaneously, or may be controlled in timing which can be regarded as simultaneously. Alternatively, by controlling the emerging state in timing with a certain or uncertain time delay with respect to a certain or uncertain direction, the feeling that a user traces Braille with the finger or the like may be realized. In this case, moreover, the direction related to the delay may be changed in accordance with a position where the perceptive point is formed. Namely, in some cases, as opposed to the normal case of tracing Braille, a user needs to trace the perceptive point, with the palm facing to himself (or herself), so that the aspect of changing the emerging state may be constructed variable so as to reduce or dissolve such a sensory error or uncomfortable feeling.

In one aspect of the mobile information input/output apparatus of the present invention, the Braille displaying device is disposed such that the perceptive point is on a rear side of the case.

According to this aspect, the Braille displaying device is disposed such that the perceptive point is on the rear side of the case, so that it is naturally realized that a user perceives the Braille pattern through the perceptive point while operating the operating device, which is preferable.

Incidentally, the “rear side” is a term responding to the “front side”, and it represents the positional relationship of the case. Therefore, during actual use of the mobile information input/output apparatus of the present invention, whichever side faces a user, or even if it is used so that neither side faces a user, the above-mentioned effects can be received without change.

In another aspect of the mobile information input/output apparatus of the present invention, the Braille displaying device is provided with at least one columnar pin portion adapted to be raised with respect to a reference surface, as the unit Braille block.

According to this aspect, the unit Braille block of the Braille displaying device is constructed including at least one pin portion, and the Braille pattern is expressed by raising the pint portion with respect to the reference surface. Thus, a natural operation feeling can be obtained, which is preferable. Incidentally, as long as the pin portion is columnar, its detailed shape, material, and the like are not limited at all. Moreover, the reference surface is a real or virtual surface on which the perceptive point can function as the Braille pattern due to a difference of elevation between the pin portion which is at least not raised with respect to the reference surface and the pin portion which is raised with respect to the reference surface. For example, the reference surface may be located in the same surface as the case.

In another aspect of the mobile information input/output apparatus of the present invention, it is further provided with a displaying device capable of displaying visual information corresponding to the performed function.

For the visually impaired, even if there is provided the displaying device, such as, e.g. a liquid crystal display apparatus and FL (Fluorescent displays), which can display the visual information, it is hard to visually recognize the visual information displayed on the displaying device; however, because of the provision of the displaying devices, practically useful effects are expected, such as letting the unimpaired see the content of an email or the like which has no problem to be seen in terms of privacy, or letting the unimpaired check the content of sentence information, such as an email, created by the visually impaired. Moreover, by providing such a displaying device, it is possible to use one portion of the platform of an existing mobile phone, PDA, or the like, to thereby establish the mobile information input/output apparatus of the present invention, which is practically useful.

In another aspect of the mobile information input/output apparatus of the present invention, the operating device includes a plurality of buttons, at least one character being assigned to each of the buttons, the function performing device can generate text data including an email, as at least one portion of the functions set in advance, and the Braille pattern data generating device generates the Braille pattern data related to the Braille pattern corresponding to the character assigned to each of the plurality of buttons on which the operation is performed while the text data is generated.

According to this aspect, the function performing device is adapted to generate the text data including an email, as one of the functions set in advance, on the basis of the operation of the operating device including the plurality of buttons, so that it is practically useful.

The Braille pattern data generating device analyzes, at each time, the character assigned to the operated button, as occasion demands, while the text data is generated by the function performing device, and it generates, as the Braille pattern data, for example, identification data for identifying the character used for an email, notification data for notifying the Braille pattern corresponding to the character, or display data for displaying the Braille pattern corresponding to the character through the Braille displaying device (or drive data for driving the displaying device), or the like. Incidentally, in the mobile information input/output apparatus of the present invention, the “character” widely includes alphabets, kana, numbers, and the like.

Therefore, while creating a document, such as an email, a user as the visually impaired can confirm, through the perceptive point, the characters typed by himself (or herself) with the buttons, with confidentiality and high accuracy ensured with respect to a third party, in real time through the perceptive point of the displaying device, or a certain or uncertain time later, or at a stage when a certain degree of characters are typed. Namely, the effect of the present invention is remarkably demonstrate, which is to improve the operability in providing the information to the visually impaired.

In another aspect of the mobile information input/output apparatus of the present invention, the function performing device can read text data including an email, as at least one portion of the functions set in advance, and the Braille pattern data generating device sequentially generates the Braille pattern data related to the Braille patterns corresponding to the characters constituting the text data, in synchronization with or in tandem with the reading of the text data.

According to this aspect, the function performing device is constructed to read the text data (which may be performed in synchronization with the visual display through the displaying device if the displaying device is provided), such as an email, obtained through, e.g., a radio communication network, as one of the functions set in advance (in which case, the obtainment of the email is also one of the functions set in advance). Incidentally, the expression “to read” described herein indicates that the text data is used for the confirmation by a user, on the basis of the user's reading will (e.g. the proper operation of the operating device).

The Braille pattern data generating device sequentially generates the Braille pattern data related to the Braille patterns corresponding to the characters constituting the text data, in synchronization with or in tandem with the reading of the text data. Namely, in the mobile information input/output apparatus of the present invention, as long as the characters actually displayed as Braille through the Braille displaying device can maintain the arrangement order of the text data, the generating timing of the Braille pattern data may be in effect arbitrary, regardless of whether or not the text data is actually read.

For example, if the Braille pattern data is generated in synchronization with the reading of the text data, considering that the controlling device controls the Braille displaying device on the basis of the generated Braille pattern data, a time interval between the generation timing of the Braille pattern data about one character and the generation timing of the Braille pattern data about a next character may be set necessary and sufficient enough for the visually impaired to recognize the characters in Braille, on the basis of experiments, experiences, or simulations or the like in advance.

Moreover, in an aspect in which the Braille pattern data is generated before the reading text data, for example, with regard to emails in the unread state of a certain amount, or of an uncertain amount set in accordance with a system load, the Braille pattern data may be generated in advance, and temporarily stored in an appropriate storing device, such as a buffer memory and RAM (Random Access Memory).

In another aspect of the mobile information input/output apparatus of the present invention, it is further provided with a fixing device for fixing at least one portion of the Braille displaying device so that a relative position of the perceptive point with respect to the case is variable.

According to this aspect, the respective position of the perceptive point with respect to the case is set variable by the setting device, so that an optimum operation feeling can be obtained, depending on the physical features, operation style, or habits or the like of individual users as the visually impaired. The visually impaired apparently need to depend on the sensory feeling, compared to the unimpaired. Thus, if the operation feeling can be optimized, the effect of the present invention can be realized, more remarkably, without giving extra stress.

Incidentally, the fixing device may have any physical, electrical, mechanical, or mechanistic structure, as long as it can fix at least one portion of the Braille displaying device so that the relative position of the perceptive point with respect to the case is variable. For example, the fixing device may have such a structure that it can slide at least one portion of the Braille displaying device including the perceptive point in a predetermined direction (i.e. one-dimensionally), or slide it in a predetermined area (i.e. two-dimensionally), or rotate it in a predetermined space (i.e. three-dimensionally). Moreover, depending on the dominant hand of the visually impaired as a user, for example, a position for the right-handed and a position for the left-handed are set in advance, and the position can be changed between the two.

In another aspect of the mobile information input/output apparatus of the present invention, it is further provided with a setting device for setting at least one of the emerging speed and emerging timing of each of the unit Braille blocks when the emerging state is controlled, the controlling device controlling the emerging state of each of the unit Braille blocks on the basis of the set at least one.

According to this aspect, by virtue of the setting device, which can adopt various forms, such as various processors, like a CPU or MPU, various electronic control units or a computer system, at least one of the emerging speed and emerging timing of each of the unit Braille blocks is set, by the operation through the operating device, or by performing operation or calculation according to some algorithm on the apparatus side on the basis of various elements which can estimate a user's proficiency, such as, e.g., a history of a redisplay request or an error in operation while using the apparatus or in operation by the operating device. Thus, depending on a user's individual specific situation, such as, e.g. whether the user is right-handed or left-handed, or what the user's Braille proficiency is like, the emerging speed and the emerging timing can be optimized, so that practically extremely useful effects can be provided.

Incidentally, in this aspect, the setting device may set at least one of the emerging speed and emerging timing of each of the unit Braille blocks so that the Braille pattern is scrolled in a predetermined direction.

In this case, a user finds the feeling as if the user traced Braille, so that the operation feeling extremely similar to the normal Braille perceptive operation can be realized, and it is practically useful.

<Versatile Braille Output Apparatus>

The above object of the present invention can be achieved by a versatile Braille output apparatus which can be carried and which is used for a predetermined types of electronic equipment, the versatile Braille output apparatus provided with: a jointing device which can be jointed to one portion of a human body: a connecting device for making an electrical connection with the electronic equipment; a Braille displaying device including a plurality of unit Braille blocks, which can emerge and which are arranged at predetermined intervals to each other, the Braille displaying device capable of displaying a plurality of Braille patterns in accordance with an emerging state of each of the unit Braille blocks, a perceptive point for perceiving the displayed Braille patterns being exposed so as to face the one portion of the human body while the jointing device is jointed to the one portion of the human body; an obtaining device for obtaining information corresponding to a function performed on the electronic equipment through the connecting device; a Braille pattern data generating device for generating Braille pattern data related to the Braille pattern corresponding to the performed function on the basis of the obtained information; and a controlling device for controlling the emerging state of each of the unit Braille blocks so that the Braille pattern corresponding to the performed function is displayed by the Braille displaying device as at least one portion of the plurality of Braille patterns, on the basis of the generated Braille pattern data.

The versatile Braille output apparatus of the present invention is provided with the jointing device which can be jointed in various aspects, such as putting (or wearing), winding, or hooking it, to one portion of a human body, such as a finger of a dominant hand. During actual use, the versatile Braille output apparatus is jointed to one portion of the human body, preferably through the jointing device.

Moreover, the versatile Braille output apparatus of the present invention is electrically connected to the predetermined types of electronic equipment through the connecting device constructed as various connectors of a D-sub type or a pin type or the like. The predetermined types of electronic equipment herein includes electronic equipment which can supply the information corresponding to the performed function through the connecting device, and may be, for example, various information communicating apparatuses, such as a mobile phone and PDA, a recording/reproducing apparatus using a HDD and DVD, a television apparatus, such as a plasma TV, various audio and visual apparatus, such as an audio apparatus and a car navigation apparatus, various electric appliances, or their accessory remote control apparatuses or the like.

According to the versatile Braille output apparatus of the present invention, upon its operation, the information corresponding to the function performed on the electronic equipment is obtained by the obtaining device from the electronic equipment through the connecting device, wherein the obtaining device can adopt various forms, such as various processors, like a CPU or MPU, various electronic control units or a computer system. Then, as described in the mobile information input/output apparatus of the present invention, through the generation of the Braille pattern data by the Braille pattern data generating device and the control of the emerging state by the controlling device, the Braille pattern is displayed by the Braille displaying device.

Particularly here, on the Braille displaying device, the perceptive point for perceiving the displayed Braille patterns is exposed so as to face the one portion of the human body while the jointing device is jointed to the one portion of the human body. Moreover, the Braille patterns displayed together with the performance of the function on the electrically connected electronic equipment are perceived by a user as the visually impaired, at least without inhibiting the operation of the electronic equipment or the like, and preferably with hardly requiring the operation for perceiving the Braille pattern. Therefore, according to the versatile Braille output apparatus of the present invention, a user can receive the above-mentioned various effects, without particular awareness of the presence during actual use, with high versatility maintained.

Incidentally, by connecting the versatile Braille output apparatus of the present invention to a mobile information input/output apparatus, such as a mobile phone, the same structure as that of the above-mentioned mobile information input/output apparatus of the present invention can be easily realized. Therefore, in response to various aspects of the above-mentioned mobile information input/output apparatus of the present invention, the versatile Braille output apparatus of the present invention can also adopt various aspects.

As explained above, the mobile information input/output apparatus of the present invention is provided with: the case; the operating device; the function performing device; the Braille displaying device; the Braille pattern generating deice; and the controlling deice, so that it can improve the operability n providing the information for the visually impaired in Braille.

As explained above, the versatile Braille output apparatus of the present invention is provided with: the jointing device; the connecting device; the Braille displaying device; the obtaining device; the Braille pattern generating deice; and the controlling deice, so that it can improve the operability n providing the information for the visually impaired in Braille.

The nature, utility, and further features of this invention will be more clearly apparent from the following detailed description with reference to preferred embodiment of the invention when read in conjunction with the accompanying drawings briefly described below.

### BRIEF DESCRIPTION OF THE DRAWINGS

FIG. 1 is a schematic plan view showing a mobile phone in a first embodiment of the present invention;

FIG. 2 is a schematic plan view showing an operation device of the mobile phone in FIG. 1;

FIG. 3 is another schematic plan view showing the mobile phone in the first embodiment of the present invention;

FIG. 4 is an A-A′ cross sectional view in FIG. 3;

FIG. 5 are schematic prospective views showing a Braille display device shown in FIG. 3;

FIG. 6 is a block diagram showing the mobile phone in the first embodiment of the present invention;

FIG. 7 is a view showing a correlation between various events occurring on the mobile phone shown in FIG. 6 and corresponding processes;

FIG. 8 is a flowchart showing a basic control process performed by a CPU in FIG. 6;

FIG. 9 is a flowchart showing a Braille pattern data generation process branched from the basis control process;

FIG. 10 is a flowchart showing a normal standby process branched form the basis control process;

FIG. 11 is another schematic perspective view showing the Braille display device;

FIG. 12 is a flowchart showing an unread mail reading standby process branched from the basis control process;

FIG. 13 is another flowchart showing the normal standby process; and

FIG. 14 is a schematic perspective view showing a versatile Braille output apparatus in a second embodiment of the present invention.

### DETAILED DESCRIPTION OF THE PREFERRED EMBODIMENTS

Hereinafter, the embodiments of the present invention will be discussed with reference to the drawings, as occasion demands.

### First Embodiment

<Structure of Embodiment>

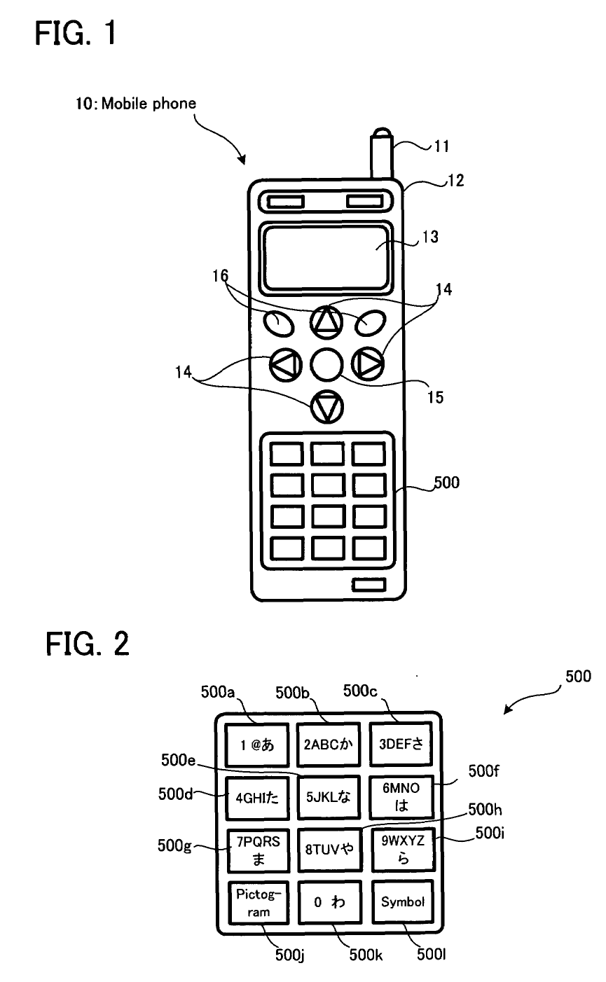

Firstly, with reference to FIG. 1, the structure of a mobile phone 10 in the present invention will be explained. FIG. 1 is a schematic plan view showing the mobile phone 10 on the front side.

In FIG. 1, the mobile phone 10 is one example of the “mobile information input/output apparatus” of the present invention, included in a not-illustrated phone communication network via an antenna 11 and adapted to send or receive emails and telephone calls with respect to the exterior. Incidentally, the mobile phone 10 is aimed at the visually impaired, and in the following explanation, a “user” indicates, unless otherwise noted, the visually impaired.

In FIG. 1, the mobile phone 10 is provided with: the above-mentioned antenna 11; a case 12; a display screen device 13; direction keys 14; a determination key 15; mode keys 16; and an operation device 500.

The case 12 is a resin body which can be carried in one hand, containing various control units and various electronic circuits or the like of the mobile phone 10. The case 12 is one example of the “case” of the present invention.

The display screen device 13 is a liquid crystal panel adapted to display various visual information associated with the mobile phone 10, such as, e.g., a phone number related to a phone call, an email address, and texts of an email. The display screen device 13 is one portion of a display device 700 described later.

The direction keys 14 are button switches which are used in various operations described later, as occasion demands, and whose surfaces are formed to be substantially as even as the case 12 (or formed not to project too much from the case 12). The direction keys 14 are used, for example, to vertically scroll a list related to a call history (or call register) or unread mail, or to select a particular third party in an electronic address book, or for similar cases.

The determination key 15 is a button switch, like the direction keys 14 or the like, which can be used for various determination operations in various operations described later.

The mode keys 16 are constructed as the button switches, like the direction keys 14 and the determination key 15, and adapted to be used for an operation of selecting various function modes of the mobile phone 10.

The operation device 500 is formed of button switches adapted to input various characters, such as kana, numbers, and alphabets, frequently used for the creation of an email and a phone call or the like. A plurality of characters are assigned in advance to the plurality of character keys (described later) constituting the operation device 500.

Incidentally, each of the direction keys 14, the determination key 15, the mode keys 16, and the operation device 500 is one example of the “operating device” of the present invention.

Next, with reference to FIG. 2, the detailed structure of the operation device 500 will be explained. FIG. 2 is a schematic plan view showing the operation device 500. Incidentally, in FIG. 2, the same or repeated positions as those in FIG. 1 carry the same numerical references, and the explanation thereof will be omitted, as occasion demands.

In FIG. 2, the operation device 500 is provided with a plurality of character keys 500a, 500b, 500c, 500d, 500e, 500f, 500g, 500h, 500i, 500j, 500k, and 500l (i.e. one example of the “button” of the present invention).

The plurality of characters (kana, numbers, alphabets, or symbols, and so on) are assigned in advance to the individual character key, and in various operations described later, a user can use the character keys for input, as occasion demands. For example, characters of “1”, “@”, and “b” are assigned in advance to the character key 500a. Incidentally, the explanation about the individual character keys will be omitted.

In the embodiment, a Braille pattern which is specific to the individual character key is physically formed on the surface of the individual character key, and if holding the mobile phone 10 in one hand, a user can identify the individual key with, e.g., a thumb or the like of the hand. Incidentally, the above-mentioned direction keys 14, determination key 15, and mode keys 16 also have the physical Braille patterns formed in the same manner, assisting the user's operations. Incidentally, the Braille pattern is not necessarily formed on all the keys, but it may be formed only on a single or a plurality of reference keys in advance. In this case, it is preferable to somehow notify the user of a relative positional relationship between the reference key and another key.

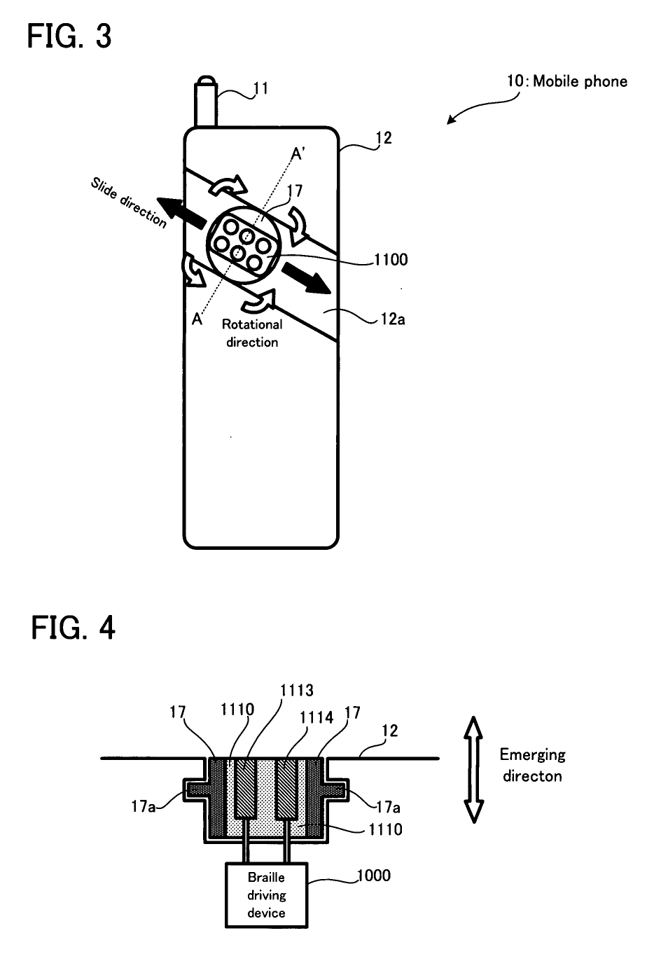

Next, with reference to FIG. 3, the further structure of the mobile phone 10 will be explained. FIG. 3 is another schematic plan view showing the mobile phone 10 on the rear surface side (i.e. the rear side of the front surface side of FIG. 1). Incidentally, in FIG. 3, the same or repeated positions as those in FIG. 1 carry the same numerical references, and the explanation thereof will be omitted, as occasion demands.

In FIG. 3, in one portion of the case 12 on the rear side of the mobile phone 10, a band-like groove 12a is formed from the upper left portion to the center right portion of the drawing. Incidentally, the groove 12a in the embodiment is defined as including not only a wall surface and a bottom surface, which define a band-like space formed by the groove 12a, but also the band-like space itself.

A disc-shaped fixing device 17 is grooved in the groove 12a, and moreover, a Braille display device 1100 is fixed on the disc-shaped fixing device 17. Incidentally, the detailed structure of the Braille display device 1100 will be described later.

The fixing device 17 is adapted to be displaced in the groove 12a in a predetermined range in an illustrated slide direction and to rotate in an illustrated rotational direction in an arbitrary position. The fixing device 17 is one example of the “fixing device” of the present invention.

Now, with reference to FIG. 4, the detailed structure of the fixing device 17 will be explained. FIG. 4 is an A-A′ cross sectional view in FIG. 3. Incidentally, in FIG. 4, the same or repeated positions as those in FIG. 1 carry the same numerical references, and the explanation thereof will be omitted, as occasion demands.

In FIG. 4, the groove 12a (whose numerical reference is omitted) has a depression in which one portion of a side wall surface is depressed toward the exterior, and one portion of the fixing device 17 is a convex 17a opposed to the depression and capable of engaging the depression. The fixing device 17 can be displaced in the slide direction which extends the vertical direction to the sheet of paper by engaging the convex 17a in the depression. Moreover, engaging the convex 17a in the depression in this manner allows the rotation in the above-mentioned rotational direction.

The Braille display device 1100 has a substrate 1110 fixed by that the fixing device 17 pinches their both sides, and has two Braille pins 1113 and 1114 embedded around the center of the substrate 1110. Incidentally, each of the two Braille pins is one example of the “unit Braille block” of the present invention. In FIG. 4, the two Braille pins are both connected to a Braille driving device 1000 described later and are adapted to emerge in an illustrated emerging direction by virtue of the Braille driving device 1000.

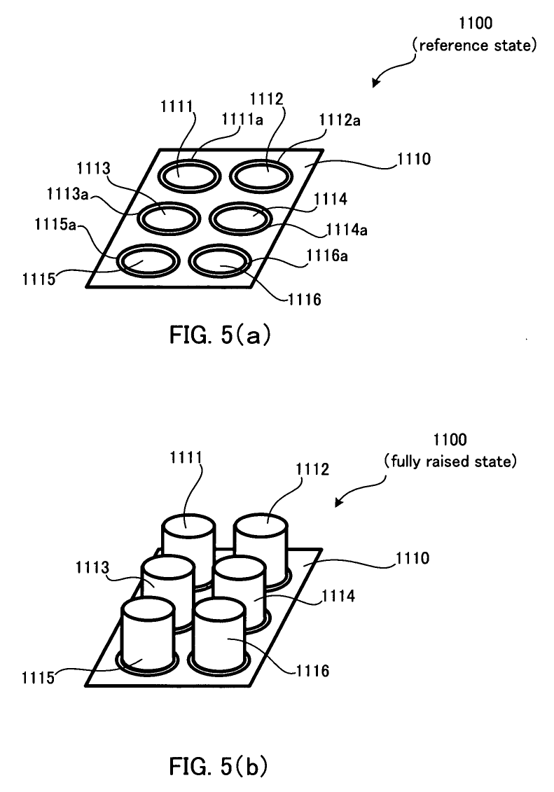

Next, with reference to FIG. 5, the detailed structure of the Braille display device 1100 will be explained. FIG. 5 are schematic prospective views showing the Braille display device 1000. Incidentally, in FIG. 5, the same or repeated positions as those in FIG. 1 carry the same numerical references, and the explanation thereof will be omitted, as occasion demands.

In FIG. 5, FIG. 5(a) shows a reference state of the Braille display device 1100. The substrate 1110 of the Braille display device 1100 is provided with six storage holes 1111a, 1111b, 1111c, 1111d, 1111e, and 1111f, and each of the six storage holes stores respective one of Braille pins 1111, 1112, 1113, 1114, 1115, and 1116. In the reference state, all the Braille pins are stored in the respective storage holes.

On the other hand, FIG. 5(b) shows a fully raised state of the Braille display device 1100. In the fully raised state, all the Braille pins are raised from the respective storage holes. The mobile phone 10 in the embodiment is adapted to individually control the emerging state of the Braille pins in each process described later and to express various Braille patterns. Incidentally, the individual one of the Braille pins is, namely, one example of the “unit Braille block” of the present invention.

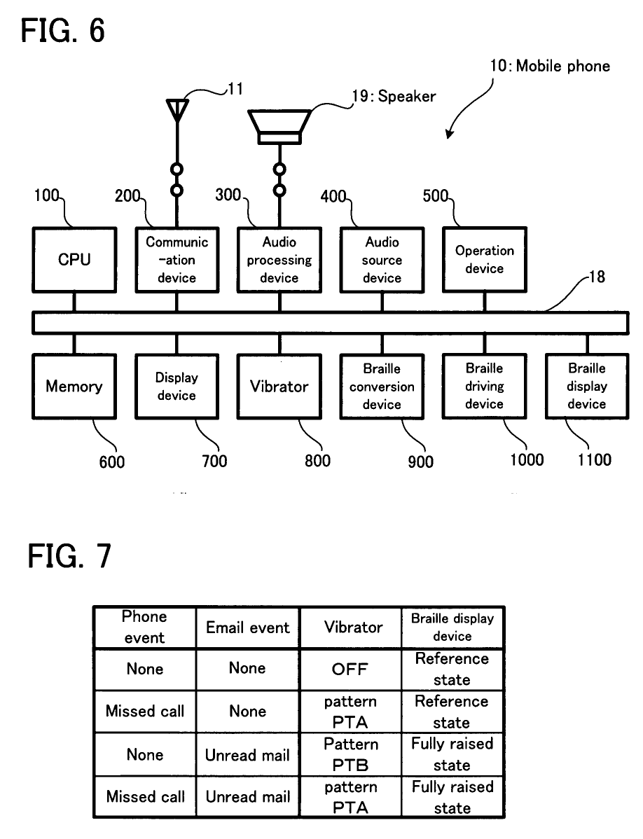

Next, with reference to FIG. 6, the electric structure of the mobile phone 10 will be explained. FIG. 6 is a block diagram showing the mobile phone 10. Incidentally, in FIG. 6, the same or repeated positions as those in FIG. 1 carry the same numerical references, and the explanation thereof will be omitted, as occasion demands.

In FIG. 6, the mobile phone 10 is provided with: a CPU 100; a communication device 200; an audio processing device 300; an audio source device 400; the operation device 500; a memory 600; a display device 700; a vibrator 800; a Braille conversion device 900; the Braille driving device 1000; and the Braille display device 1100, which are electrically connected to each other through a control bus 18.

The CPU 100 is a control unit for controlling the operation of the mobile phone 10, and is adapted to function as one example of the “function performing device” and the “controlling device” of the present invention. The CPU 100 is adapted to perform each process described later, in accordance with a control program stored in the memory 600.

The communication device 200 is a processing unit adapted to perform various high-frequency processing, intermediate-frequency processing and the like, related to the sending and reception of an email and a phone call, such as making or receiving a phone call, via the antenna 11. Incidentally, the operation of the communication device 200 is the same as that of a so-called general mobile phone, and the explanation thereof will be omitted in the embodiment.

The audio processing device 300 is an audio processing unit adapted to generate an audio signal to be outputted from a speaker 19 and supply it to the speaker 19, on the basis of audio signal data or the like related to a received sound supplied via the control bus 18 from the communication device 200 and audio signal data related to ringtone and sound effect supplied from via the control bus 18 from the audio source device 400.

The audio source device 400 is adapted to generate and supply audio data related to ringtone and sound effect or the like.

The operation device 500 is provided with the plurality of character keys, as described above. All the character keys are electrically connected to the control bus 18. The CPU 100 is adapted to specify which key is operated via the control bus 18 if an operation is performed through the operation device 500. Incidentally, it is not illustrated to prevent the complexity of the drawing, but the above-mentioned direction keys 14, determination key 15, and mode keys 16 are also electrically connected to the control bus 18. Namely, the CPU 100 can specify the operated key, as in the operation device 500, even with regard to the above-mentioned keys.

The memory 600 is a storage element including a nonvolatile storing device, such as a ROM, for storing therein control programs used for the CPU 100, and a volatile storing device, such as a RAM, for temporarily storing therein various data generated in various control processes realized by the various control programs.

The display device 700 is a liquid crystal apparatus including the above-mentioned display screen device 13, and includes a control circuit or the like for drive-controlling the display screen device 13 on the basis of image data and video data as for images and video to be displayed on the display screen device 13.

The vibrator 800 is a vibration generator for transmitting vibration to a user via the case 12, and is adapted to notify the user of a plurality of states of the mobile phone 10 by setting in advance a plurality of patterns of vibration.

The Braille conversion device 900 is adapted to generate Braille pattern data corresponding one-on-one to a character included in text information, such as, e.g. a title, sender, and message body, as for an incoming email, and text information or the like as for an email to be sent, generated through the operation of the operation device 500 or the like. The Braille conversion device 900 is one example of the “Braille pattern data generating device” of the present invention. Incidentally, in the embodiment, the Braille data pattern is drive data, used for the drive-control of the Braille display device 1100 performed by the Braille driving device 1000.

The Braille driving device 1000 is a drive mechanism including e.g. an electric actuator or the like, capable of making each of the Braille pins, which constitute the Braille display device 1100, emerge in the above-mentioned emerging direction, as occasion demands. Incidentally, the mechanism of displaying the Braille pattern via the Braille display device 1100 or the like can adopt various known aspects, and the detailed explanation thereof will be omitted here.

<Operation of Embodiment>

On the mobile phone 10, various control processes are performed by the CPU 100. Hereinafter, as the operation of the embodiment, the various control processes will be explained.

<Basic Control Process>

<Concept of Basic Control Process>

The mobile phone 10 having the above-mentioned structure can accurately and certainly notify a user of various events generated passively (i.e. in real time, regardless of the user's operation) on the mobile phone 10 by the drive-control of the Braille display device 1100 and the vibrator 8900 in the basic control process.

Now, with reference to FIG. 7, the processes for the passive various events will be explained. FIG. 7 is a view showing a correlation between the various events and the corresponding processes.

In FIG. 7, as the passive events, there are set a phone event and an email event. Namely, the phone event indicates the presence or absence of an incoming call from a third party, generated mainly in a user's absence or without the user's knowing (including the presence or absence of a message received by an answering machine). The email event namely indicates the presence or absence of an unread mail received mainly in a user's absence or without the user's knowing, or in an unread state though the user has already known the incoming mail.

In FIG. 7, four types of event states can be considered from the combination of the phone event and the email event; namely, beginning at the top, a case where there is no missed call nor unread mail (hereinafter referred to as a “first event condition”), a case where there is only a missed call (hereinafter referred to as a “second event condition”), a case where there is only an unread mail (hereinafter referred to as a “third event condition”), and a case where there are both a missed call and an unread mail (hereinafter referred to as a “fourth event condition”).

In the first event condition, the vibrator 800 is controlled into an inactive state, and the Braille display device 1100 is controlled into the above-mentioned reference state (i.e. in the state that all the Braille pins are stored in the storage holes).

In the second event condition, the vibrator 800 is controlled to vibrate in a pattern PTA, which is a vibration pattern set in advance as notifying the presence of a missed call. Moreover, the Braille display device 1100 is controlled into the reference state.

In the second event condition, the vibrator 800 is controlled to vibrate in a pattern PTB, which is a vibration pattern set in advance as notifying the presence of an unread mail. Moreover, the Braille display device 1100 is controlled into the fully raised state (i.e. in the state that all the Braille pins are raised).

In the fourth event condition, the vibrator 800 is controlled to vibrate in the pattern PTA, and the Braille display device 1100 is controlled into the fully raised state to show a difference from the second event condition.

<Details of Basic Control Process>

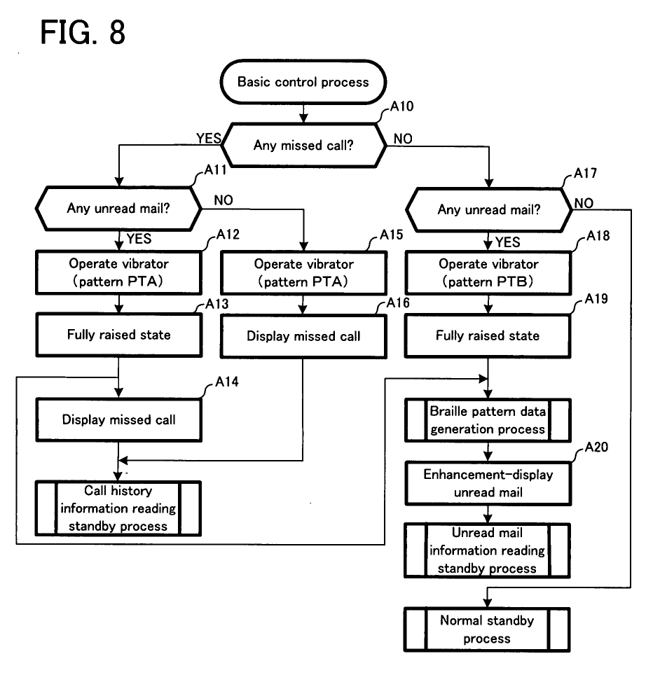

Next, with reference to FIG. 8, the details of the basic control process will be explained. FIG. 8 is a flowchart showing the basic control process.

In FIG. 8, the CPU 100 judges whether or not there is a missed call (step A10). If there is a missed call (the step A10: YES), the CPU 100 further judges whether or not there is an unread mail (step A11).

If there is an unread mail (the step A11: YES), the CPU 100 operates the vibrator 800 in the pattern PTA (step A12), and also controls the Braille driving device 1000 to thereby drive-control the Braille display device 1100 into the fully raised state (step A13).

After the drive-control of the Braille display device 1100 and the vibrator 800, the CPU 100 drive-controls the display device 700 to thereby perform a missed call display, such as, e.g., displaying a message of “you have a missed call” on the display screen device 13 (step A14). Incidentally, this situation is equivalent to a situation where the above-mentioned fourth event condition is satisfied.

After the missed call display, the CPU 100 performs a call history information reading standby process, as one of sub routines. Incidentally, the explanation of the call history information reading standby process will be omitted. Incidentally, after the process in the step A14, the CPU 100 performs a Braille pattern data generation process, in parallel with the call history information reading standby process, as one of the sub routines. The Braille pattern data generation process will be discussed later.

On the other hand, if it is judged there is no unread mail in the process in the step A11 (the step A11: NO), the CPU 100 operates the vibrator 800 in the pattern PTA (step A15), enables the display device 700 to perform the missed call display (step A16), and performs the call history information reading standby process. Incidentally, this situation is equivalent to a situation where the above-mentioned second event condition is satisfied.

On the other hand, if there is no missed call (the step A10: NO), the CPU 100 judges whether or not there is an unread mail (step A17). If there is no unread mail (the step A17: NO), namely, in case of the above-mentioned first event condition, the CPU 100 performs a normal standby process. Incidentally, the normal standby process will be discussed later.

In the process in the step A17, if it is judged that there is an unread mail (the step A17:YES), namely, if the above-mentioned third event condition is satisfied, the CPU 100 operates the vibrator 800 in the above-mentioned pattern PTB (step A18), and drive-controls the Braille display device 1100 into the fully raised state (step A19).

After operating each of the vibrator 800 and the Braille display device 1100 in the appropriate pattern and mode, the CPU 100 performs the Braille pattern data generation process. After the Braille pattern data generation process, the CPU 100 drive-controls the display device 700 to display the unread mail in an enhancement state on the display screen device 13 (step A20). Incidentally, a user is the visually impaired and the display of information onto the display screen device 13 seems nonsense; however if the information is displayed on the display screen device 13, a surrounding third party may give an appropriate notification to the user, so that it is practically useful.

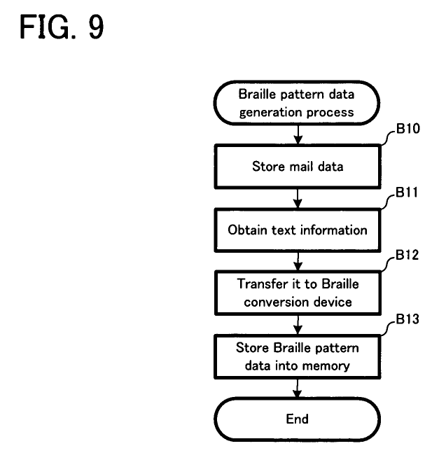

Next, with reference to FIG. 9, the Braille pattern data generation process will be explained. FIG. 9 is a flowchart showing the Braille pattern data generation process.

In FIG. 9, firstly, the CPU 100 temporarily stores, into the memory 600, mail data as for an email obtained via the communication device 200 (step B10). After storing the mail data into the memory 600, the CPU 100 analyzes the stored mail data and obtains the text information included in the email defined by the mail data (step B11). At this time, more specifically, kanji included in the email is converted into hiragana, and symbols are ignored. In the end, what is obtained is the text information formed of kana, numbers, and alphabets, i.e. the text information formed of only characters which can be expressed in Braille.

After obtaining the text information, the CPU 100 transfers the obtained text information to the Braille conversion device 900 (step B12). On the forwarding Braille conversion device 900, under the control of the CPU 100, the Braille pattern data corresponding to the transferred text information is generated correspondingly one-on-one to the characters constituting the text information.

The Braille conversion device 900 further sequentially stores the generated Braille pattern data into the memory 600 for each unread mail in accordance with the control of the CPU 100 (step B13). If the Braille pattern data as for all the mail data temporarily stored in the memory 600 is stored into the memory 600, the Braille pattern data generation process ends.

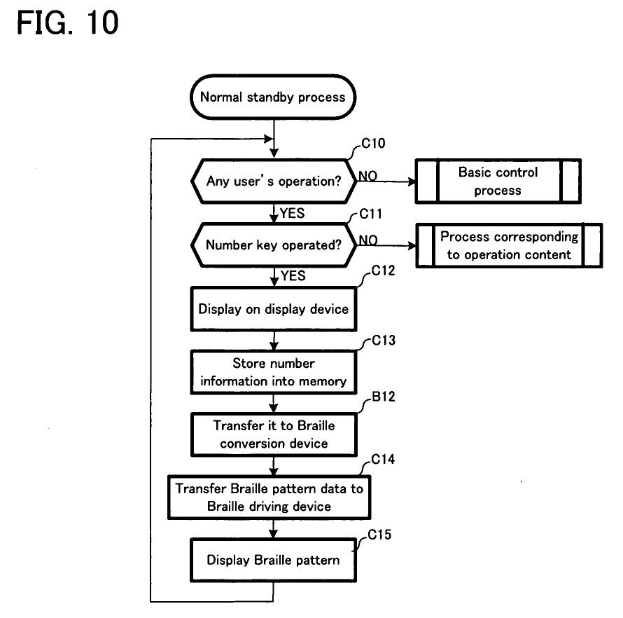

Next, with reference to FIG. 10, the normal standby process will be explained. FIG. 10 is a flowchart showing the normal standby process. Incidentally, in FIG. 10, the same or repeated processes as those in FIG. 9 carry the same numerical references, and the explanation thereof will be omitted, as occasion demands. Incidentally, in the normal standby process, of course, functions assigned one-on-one to various operations performed in a standby state are performed, but showing all of their processing procedures is redundant. Also, for the purpose of preventing the complexity of the drawing, in FIG. 10, only a process as for the operation of a phone number (i.e. numbers) in a phone call will be explained.

In FIG. 10, the CPU 100 judges whether or not there is a user's operation (step C10). If there is no user's operation (the step C10: NO), the CPU 100 moves the process from the normal standby process as a sub routine to the basic control process as a main routine, and repeats the above-mentioned basic control process. Incidentally, in the process in the step C10, whether or not there is a user's operation is judged on the basis of, e.g., whether or not a time-out period set in advance has passed since the start of the normal standby process. Incidentally, as is clear from the basic control process, if there is no missed call, no unread mail, nor user's operation, the mobile phone 10 is practically controlled into the standby state.

If there is a user's operation (the step C10: YES), the CPU 100 judges whether or not the operated key is a key to which a number is assigned (hereinafter referred to a “number key”, as occasion demands) on the operation device 500 (step C11). Namely, the number key indicates any of the keys or the character keys other than the character keys 500j and 500l, out of the character keys provided for the operation device 500.

If the operated key is not the number key (the step C11: NO), the CPU 100 performs a process corresponding to the operation content. Incidentally, as already specified, the details of the various processes corresponding to the operation content will be omitted.

If the operated key is the number key (the step C11: YES), the CPU 100 drive-controls the display device 700, to thereby display a number corresponding to the operated number key on the display screen device 13 (step C12). At the same time, the CPU 100 stores, into the memory 600, number information for identifying the numbers (step C13). On the other hand, the number information stored in the memory 600 is transferred to the Braille conversion device 900 by the control of the CPU 100 (the step B12).

On the Braille conversion device 900, as already specified, the Braille pattern data corresponding to the transferred number information is generated. The CPU 100 controls the Braille conversion device 900 to supply the generated Braille pattern data to the Braille driving device 1000 (step C14).

The Braille driving device 1000 raises the Braille pins to be raised, out of the Braille display device 110, on the basis of the supplied Braille pattern data, to thereby display the Braille pattern (step C15).

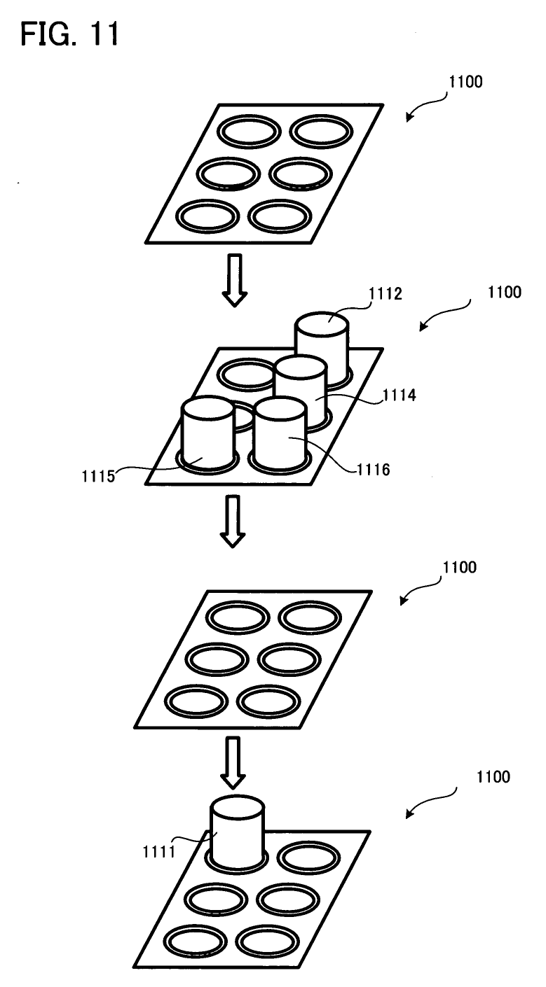

Now, with reference to FIG. 11, an operation example of the Braille display device 1100 in the step in the step C15 will be explained. FIG. 11 is a schematic perspective view showing the Braille display device 1100. Incidentally, in FIG. 11, the same or repeated positions as those in FIG. 5 carry the same numerical references, and the explanation thereof will be omitted, as occasion demands.

In FIG. 11, the Braille display device 1100 is normally set in the reference state (see the top), and in the process in the step C15 of FIG. 11, the Braille display device 1100 is controlled into a raised state which indicates that the Braille to be displayed from now is numbers (see the second top). Namely, the Braille pins 1112, 1114, 1115, and 1116 are raised. After that, all the Braille pins are stored into the storage holes once (see the third top), and then it is set into a state indicating the number of “1”; namely, only the Braille pin 1111 is raised (see the bottom).

As described above, in the embodiment, when one character is displayed, firstly, the attribute of the character to be displayed (e.g. classifications of numbers, characters, or alphabets, etc.) is displayed, and secondly the target character is displayed. Therefore, a user can recognize which Braille is currently displayed, without misunderstanding and quickly.

Incidentally, considering that it is necessary to pass through a plurality of display stages (i.e. as shown in FIG. 11, a stage of displaying the attribute, a stage of displaying the character, and a stage indicating their boundary (reference state)) in order to display one character, and further considering that there is likely a great difference in level of Braille proficiency for each user, the display period of the Braille patterns at a plurality of display stages, or the raising rate or lowering rate (i.e. storage rate) of each Braille pin, may be varied by the appropriate operation from the mode keys 16, the direction keys 14, or the operation device 500. For example, if a user has a high level of Braille proficiency, the display period may be changed to be shorter, or the raising or lowering rate may be changed to be faster. Such a change can be easily realized, for example, by controlling the output of an actuator, the drive duty control of an electro magnetic valve, or controlling a voltage to be applied to an electrode, which are associated with the Braille driving device 1000.

Back in FIG. 10, at this time point, if the operated number key is a key corresponding to “1”, the Braille pattern corresponding to “1” is displayed by the Braille display device 1100. After the display of the Braille pattern corresponding to “1”, the CPU 100 returns the process to the step C10, and repeats the series of processes.

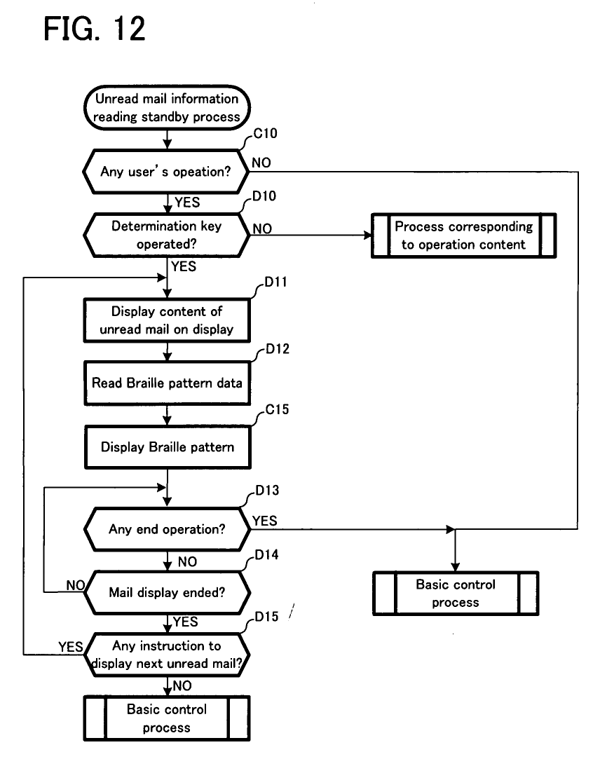

Next, with reference to FIG. 12, the details of the unread mail reading standby process will be explained. FIG. 12 is a flowchart showing the unread mail reading standby process. Incidentally, in FIG. 12, the same or repeated positions as those in FIG. 10 carry the same numerical references, and the explanation thereof will be omitted, as occasion demands.

In FIG. 12, if there is a user's operation (the step C10: YES), the CPU 100 judges whether or not the determination key 15 is operated (step D10). If the determination key 15 is not operated (the step D10: NO), as in FIG. 10, the CPU 100 performs the process corresponding to the operation content.

On the other hand, the unread mail is already enhancement-displayed (though which is not directly related to the user) by the process in the step A20 in the basic control process in FIG. 8, and in the embodiment, the determination key 15 is operated in this state, so that it is judged that the user's will to confirm the unread mail is displayed. Therefore, if the determination key 15 is operated (the step D10: YES), the CPU 100 controls the display device 700 to display the content of the unread mail on the display screen device 13 (step D11). Incidentally, in this step, the above-mentioned enhancement-displayed email is a display target. If there are a plurality of unread mails, for example, an email corresponding to the top (e.g. received at the earliest time point) or bottom (e.g. received at the latest time point) of an unread mail list may be a display target. In any cases, the user cannot visually confirm the display screen device 13, so that in which order to display unread mails in Braille may be set, individually and specifically, so as to reduce a load of the user who is the visually impaired, on the basis of experiments, experiences, or simulations or the like, in advance.

After the process in the step D11, the CPU 100 reads the Braille pattern data as for the unread mail stored in the memory 600 (step D12), and supplies the Braille pattern data to the Braille driving device 1000 to thereby display the unread mail as the Braille pattern through the Braille display device 1100 (the step C15). During the display of the unread mail, the characters constituting the unread mail described above are displayed in order by the Braille display device 1100 in the aspect described in FIG. 11.

On the other hand, during the display of the unread mail, sometimes, the user may feel like (s)he does not have to confirm the unread mail. Thus, the CPU 100 always judges whether or not there is an end operation while confirming the unread mail (step D13). The aspect of the end operation is not limited at all, and for example, it may be a predetermined operation of the mode keys 16, or the like.

If the end operation is performed (the step D13: YES), the CPU 100 moves the process to the basic control process. Incidentally, at this time point, the unread mail on which the end operation is performed is considered to be already used for the confirmation by the Braille display, and it is released from treatment as the unread mail.

If there is no end operation (the step D13: NO), the CPU 100 judges whether or not all the displays about one unread mail (i.e. a sent date and time, sender, subject, message body, etc.) are ended (step D14). If it is still during the display period of one unread mail (the step D14: NO), the CPU 100 returns the process to the step D13, and repeats the series of processes. If the displays about one unread mail are ended (the step D14: YES), the CPU 100 judges whether or not there is a next unread mail.

If there is no unread mail (i.e. if the Braille pattern data corresponding to the unread mail is not stored in the memory 600) (the step D15: NO), the CPU 100 moves the process to the basic control process. If there is the Braille pattern data as for the unread mail in the memory 600 (the step D15: YES), the CPU 100 returns the process back to the step D11 and repeats the series of processes.

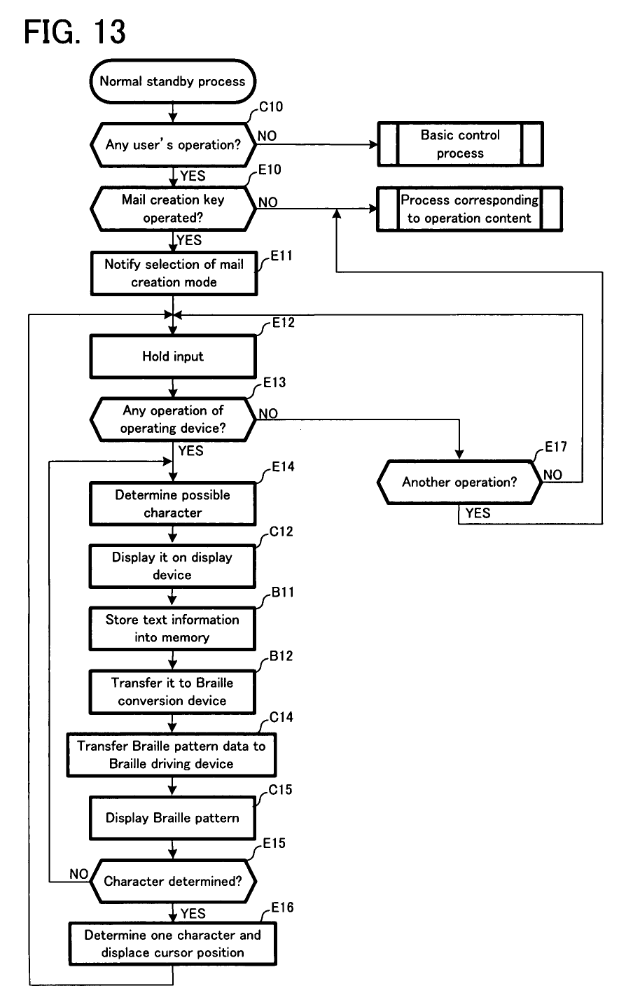

Next, with reference to FIG. 13, another aspect of the normal standby process will be explained. FIG. 13 is another flowchart showing the normal standby process. Incidentally, in FIG. 13, the same or repeated positions as those in FIG. 10 carry the same numerical references, and the explanation thereof will be omitted, as occasion demands. Incidentally, in the normal standby state, of course, functions assigned one-on-one to various operations performed in a standby state are performed, but showing all of their processing procedures is redundant. Also, for the purpose of preventing the complexity of the drawing, in FIG. 13, only a process as for an operation in newly creating an email will be explained.

In FIG. 13, the CPU 100 judges whether or not the user's operation is the operation of a mail creation key (step E10). The mail creation key herein may be set, for example, as one portion of the mode keys 16 in advance, or may be alternately defined by the operation of the determination key 15 or the like, which promotes the selection of a relevant menu on a menu screen linked from the mode keys 16.

If the user's operation is not the operation of the mail creation key (the step E10: NO), the CPU 100 performs the process corresponding to the operation content, as described above. If it is the operation of the mail creation key (the step E10: YES), the CPU 100 notifies the user of the selection of a mail creation mode, as audio information or the like obtained by controlling, e.g., the audio source device 400 and the audio processing device 300 or the like (step E11).

If notifying the selection of the mail creation mode, the CPU 100 holds the process until obtaining the user's input (step E12). In the input standby state, the CPU 100 judges whether or not an operation is performed by the operation device 500, i.e. whether or not the key associated with the email creation is operated (step E13).

If an operation is not performed by the operation device 500 (the step E13: NO), the CPU 100 judges whether or not another operation (i.e. an operation unrelated to the email creation) is performed (step E17). If another operation is not performed (the step E17: NO), the CPU 100 returns the process to the step E12 and maintains the input standby state. If another operation is performed (the step E17: YES), the CPU 100 performs the process corresponding to the operation content.

On the other hand, if an operation is performed by the operation device 500 (the step E13: YES), the CPU 100 determines a possible character (step E14). The plurality of characters are assigned in advance to each of the character keys constituting the operation device 500, so that merely operating (pressing) the character key does not make it certain which character a user desires to input. Thus, the CPU 100 determines one of the characters assigned to the operated character key as the possible character; for example, if the character key 500b is operated, the CPU 100 determines “a” to be the possible character. The determined possible character is displayed on the display screen device 13 through the drive-control of the display device 700 (the step C12).

After having the possible character displayed on the display screen device 13, the CPU 100 stores the text information related to the possible character into the memory 600 (the step B11), and further transfers the text information to the Braille conversion device 900 (the step B12). On the Braille conversion device 900, as already explained, the Braille pattern data as for the possible character is generated.

After the Braille pattern data as for the possible character is generated by the Braille conversion device 900, the CPU 100 transfers the generated Braille pattern data to the Braille driving device 1000. Then, through the drive-control of the Braille display device 1100 by the Braille driving device 1000, the possible character is displayed as the Braille pattern (the step C15).

After the possible character is displayed as the Braille pattern, the CPU 100 judges whether or not the possible character is determined as an input character (step E15). Here, whether or not to be determined as an input character is judged on the basis of whether or not the user has performed an operation (determination operation) for determining the possible character. Such a determination operation can adopt a plurality of aspects set in advance; however, for example, the operation of the key for promoting displacement to the right direction (e.g. the direction key located in the most right position) out of the direction keys 14 may be set as what corresponds to the determination operation.

If the user does not perform the determination operation (the step E15: NO), more specifically, if the operation for promoting the change of the possible character is performed through, for example, the operation of any of the direction keys 14, the CPU 100 returns the process to the step E14, determines another character which is assigned to the character key in which the operation is detected in the process in the step E13, and repeats the series of processes. On the other hand, if the user has performed the determination operation (the step E15: YES), the character displayed through the Braille display device 1100 is considered to be one character which constitutes the email, and the CPU 100 displaces a cursor position (input position) associated with the display screen device 13, returns the process to the step E12, and continues the process after the input standby status.

As explained above, according to the mobile phone 10 in the embodiment, the emerging state of each of the Braille pins on the Braille display device 1100 is variably controlled by the various processes performed by the CPU 100. Thus, the various information associated with the mobile phone 10, such as, e.g., the content confirmation of an incoming email, creation of an email, and a phone call, is provided for the user who is the visually impaired.

Particularly, here, on the Braille display device 1100, a contact point with the user (i.e. one example of the “perceptive point” of the present invention) is set on the rear side of the mobile phone 10 in accordance with the arrangement aspect of the Braille display device 1100. Therefore, if holding the mobile phone 10 in one hand, the user can perform the operations of the operation device 500, the direction keys 14, the determination key 15, and the mode keys 16 or the like, which are located on the front side, with, e.g. the thumb or the like, while perceiving the Braille pattern displayed by the Braille display device 1100 with the rest of the fingers holding the rear side. Namely, in the same manner as the unimpaired do, the user can hold and operate the mobile phone 10 in one hand, and the operability is remarkably improved as compared to the case where the both hands are forced to be used. As described above, according to the mobile phone 10 in the embodiment, it is possible to remarkably improve the operability in providing the information for the user in Braille.

Moreover, as shown in FIG. 3, on the mobile phone 10, at least each of the Braille pins used for the user's perception on the Braille display device 1100 disposed on the rear side of the mobile phone 10 can be displaced in the predetermined slide direction and it can be rotated in the predetermined rotational direction with the substrate 1110 by the operation of the fixing device 17. Thus, the position of the Braille display device 1100 with respect to the case 12 can be easily optimized depending on the user's physical features, such as the size and shape of the hand, and the user's way, feature, posture, and the like to hold the mobile phone 10. Namely, even from these points, the effect of the present invention is also effectively supported, which is improving the operability in providing the information for the user in Braille.

Incidentally, this is not practiced in the embodiment, but, for example, in FIG. 3, the convex 17a of the fixing device 17 may be made in a pin shape, and the depression in the groove 12a of the case 12 may be molded into a hole shape which fits the pin-shaped convex 17a of the fixing device 17, to thereby construct the mobile phone 10 so that the fixing device 17 can rotate in the vertical direction with respect to the sheet of paper of FIG. 3 (i.e. so as to be three-dimensionally displaced with respect to the case 12), with the pin-shaped convex as the rotation axis (i.e. with the A-A′ line in FIG. 3 as the rotation axis line).

Incidentally, in the embodiment, the aspect of raising the Braille pins on the Braille display device 1100 is not particularly specifically demonstrated, but for example, all the Braille pins may be simultaneously raised, or the Braille pins may be raised, with a time difference one another or in predetermined units. If there is the time difference, the time difference may be set from the right to the left, or from the left to the right, with respect to the A-A′ line in FIG. 3 as if, for example, the user traced the Braille pins with the finger. In this case, by increasing the number of the Braille pins on the Braille display device 1100 to thereby control the Braille pins so as to change the raising state of the Braille pins more continuously, the finger's tracing feeling can be recreated more precisely.

Incidentally, aside from whether or not the time difference is provided for the raising timing among the Braille pins, for example, some user may have an opposite feeling, compared to the normal case that the user senses Braille, with the Braille pins raised on the rear surface of the mobile phone 10. Alternatively, depending on whether the hand used to hold the mobile phone 10 is a right hand or a left hand, the feeling may be opposite in the same manner. In case that happens, e.g., the mode keys 16 or the like of the mobile phone 10 may have such a function assigned that converts the Braille pattern to a pattern which is left-right symmetric, up-down symmetric, or point-symmetric with respect to an arbitrary point. In this case, in response to the operation of the key, the Braille conversion device 900 may convert the once generated Braille pattern data so that it corresponds to the above-mentioned symmetric pattern. Alternatively, the Braille conversion device 900 may generate the Braille pattern data corresponding to such a symmetric pattern from the beginning.

Incidentally, some user may change the hand used to hold the mobile phone 10 during use or at each time of use for some reasons (e.g. change the left hand to the right hand). In that case, it is inefficient to force the user to operate the mode keys 16 or the like at each time. Moreover, considering that the user is the visually impaired, it can be said that some measures should be taken.

Thus, although this is not illustrated in FIG. 3, the mobile phone 10 may be provided with a single small sensor, preferably a plurality of small sensors or the like which can specify the relative position of the fixing device 17 or the Braille display device 1100 (or the substrate 1110) or the like with respect to the case 12 (e.g. a planar or three-dimensional rotation angle of the fixing device 17 with respect to the case 12, or an absolute position of the fixing device 17 on the case 12, or the like), with its electrical connection status with the CPU 100 maintained.

In this case, during actual use, the CPU 100 may keep monitoring the position of the fixing device 17 or the Braille display device 1100 detected by the sensors, and on the basis of the detected position, the CPU 100 may judge which hand of the user is currently used to operate the mobile phone 10, in accordance with a correlation with the actually used hand and the position, which is obtained in advance experimentally, experientially, or by simulation or the like, or in accordance with algorithm or the like set in advance.

Moreover, the CPU 100 may further judge whether the Braille pattern is to be displaced symmetrically with respect to the display aspect at the current time point as described above, or to be displaced as normal (which herein means that the pattern is not dare to be symmetric), in accordance with the judgment result about the hand used for the actual use, and make the Braille pattern emerge which is suitable for the hand the user uses to hold the mobile phone 10, automatically without a special operation by the user.

Incidentally, in the embodiment, on the Braille display device 1100, the raising direction of the Braille pins is set on the rear side of the mobile phone 10. However, the setting position of the perceptive point is not limited to the rear side as long as the user performs the various operations associated with the mobile phone 10 (the operations of the direction keys 14, the determination key 15, the mode keys 16, and the operation device 500 or the like) with the mobile phone 10 held in one hand and the user can easily and certainly perceive or sense the Braille pattern displayed in accordance with the emerging state of the Braille pins. For example, the mobile phone 10 may be constructed such that the Braille pins are raised, for example, on the side surface portion. Alternatively, in view of the three-dimensional shape of the case 12, if the two sides (i.e. front and rear sides) can be hardly defined, the raising direction of the Braille pins is not necessarily set with the particular concept of two sides. As long as the user holds the equipment in one hand and can easily perform the two different operations in one hand which are to operate the equipment and to perceive the Braille pattern, the physical, electrical, mechanical, or mechanistic aspect of the Braille display device and its position may be arbitrarily determined.

### Second Embodiment

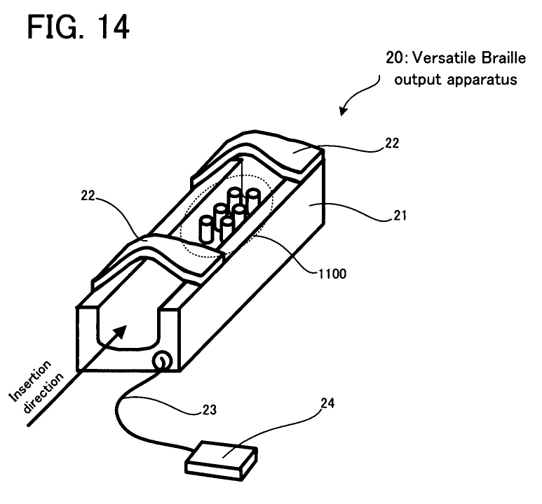

Next, with reference to FIG. 14, a versatile Braille output apparatus 20 will be explained as a second embodiment of the present invention. FIG. 14 is a schematic perspective view showing the versatile Braille output apparatus 20. Incidentally, in FIG. 14, the same or repeated positions as those in FIG. 1 carry the same numerical references, and the explanation thereof will be omitted, as occasion demands.

In FIG. 14, the versatile Braille output apparatus 20 is one example of the “versatile Braille output apparatus” of the present invention, having a finger-cot shaped substrate 21 which is made of resins and is relatively soft.

The user can insert the finger into the substrate 21 in the illustrated insertion direction. While the user's finger is inserted, stretchable rubber bands 22 located in two positions of the substrate 21 can fix the user's finger to the versatile Braille output apparatus 20. Namely, the substrate 21 and the rubber bands 22 constitute one example of the “jointing device” of the present invention.

The side surface of the substrate 21 is connected to a connecter 24 through a signal cable 23, and the signal cable 23 is electrically connected to a not-illustrated driving system and control system inside the substrate 21.

On the internal surface of the substrate 21 which is cylindrically formed, the same types of Braille pins as those in the above-mentioned first embodiment of the Braille display device 1100 are set to emerge with respect to the internal surface, near a place on which the ball of the fingertip abuts while the finger is inserted. The driving system and the control system included in the substrate 21 include the Braille driving device 1000 for driving the Braille display device 1100, the Braille conversion device 900, and the CPU 100 or the like, and these devices can variably control the emerging state of the Braille pins.

In such a structure, the connecter 24 obtains, from various electronic equipment electrically connected with the connector 24, such as, e.g. a mobile phone, PDA, and various remote controllers, information corresponding to functions performed on the electronic equipment, e.g. the various key operations or the like in the first embodiment described above, as an electrical signal or the like. The information corresponding to the functions performed on the electronic equipment is displayed as the Braille pattern through the process or control associated with the Braille conversion device 900, the Braille driving device 1000, and the Braille display device 1100, as in the above-mentioned embodiment.

As described above, the versatile Braille output apparatus 20 has such a structure that the portion associated with the Braille display is independent, compared to the first embodiment. As long as the versatile Braille output apparatus 20 is the electronic equipment adapted to supply the information corresponding to the performed functions, preferably, the character information corresponding to the performed functions as an electrical signal through the connecter 24, the same effects as those in the first embodiment can be provided for the user without limiting the connection target. Namely, it is possible to remarkably improve the operability in providing the information for the user in Braille.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2006-122678 filed on Apr. 26, 2006 including the specification, claims, drawings and summary is incorporated herein by reference in its entirety.

What is claimed is:

1. A mobile information input/output apparatus comprising:
a case which can be at least carried;
an operating device which is disposed to expose at least one portion including an operation surface on a front side of said case and which can perform an operation of indicating that at least one portion of functions is to be performed, the functions being set in advance with regard to input/output of a predetermined types of information;
a function performing device for performing a function corresponding to the input out of the functions set in advance;
a Braille displaying device including a plurality of unit Braille blocks, which can emerge and which are arranged at predetermined intervals to each other, said Braille displaying device capable of displaying a plurality of Braille patterns in accordance with an emerging state of each of the unit Braille blocks, a perceptive point for perceiving the displayed Braille patterns being set on a different side from the front side of said case;
a Braille pattern data generating device for generating Braille pattern data related to the Braille pattern corresponding to the performed function; and
a controlling device for controlling the emerging state of each of the unit Braille blocks so that the Braille pattern corresponding to the performed function is displayed by said Braille displaying device as at least one portion of the plurality of Braille patterns, on the basis of the generated Braille pattern data.

2. The mobile information input/output apparatus according to claim 1, wherein said Braille displaying device is disposed such that the perceptive point is on a rear side of said case.

3. The mobile information input/output apparatus according to claim 1, wherein said Braille displaying device comprises at least one columnar pin portion adapted to be raised with respect to a reference surface, as the unit Braille block.

4. The mobile information input/output apparatus according to claim 1, further comprising a displaying device capable of displaying visual information corresponding to the performed function.

5. The mobile information input/output apparatus according to claim 1, wherein
said operating device includes a plurality of buttons, at least one character being assigned to each of the buttons,
said function performing device can generate text data including an email, as at least one portion of the functions set in advance, and
said Braille pattern data generating device generates the Braille pattern data related to the Braille pattern corresponding to the character assigned to each of the plurality of buttons on which the operation is performed while the text data is generated.

6. The mobile information input/output apparatus according to claim 1, wherein
said function performing device can read text data including an email, as at least one portion of the functions set in advance, and
said Braille pattern data generating device sequentially generates the Braille pattern data related to the Braille patterns corresponding to the characters constituting the text data, in synchronization with or in tandem with the reading of the text data.

7. The mobile information input/output apparatus according to claim 1, further comprising a fixing device for fixing at least one portion of said Braille displaying device so that a relative position of the perceptive point with respect to said case is variable.

8. The mobile information input/output apparatus according to claim 1, further comprising a setting device for setting at least one of the emerging speed and emerging timing of each of the unit Braille blocks when the emerging state is controlled,
said controlling device controlling the emerging state of each of the unit Braille blocks on the basis of the set at least one.

9. The mobile information input/output apparatus according to claim 8, wherein said setting device sets at least one of the emerging speed and emerging timing of each of the unit Braille blocks so that the Braille pattern is scrolled in a predetermined direction.

10. A versatile Braille output apparatus which can be carried and which is used for a predetermined types of electronic equipment, said versatile Braille output apparatus comprising:
a jointing device which can be jointed to one portion of a human body:
a connecting device for making an electrical connection with the electronic equipment;
a Braille displaying device including a plurality of unit Braille blocks, which can emerge and which are arranged at predetermined intervals to each other, said Braille displaying device capable of displaying a plurality of Braille patterns in accordance with an emerging state of each of the unit Braille blocks, a perceptive point for perceiving the displayed Braille patterns being exposed so as to face the one portion of the human body while said jointing device is jointed to the one portion of the human body;
an obtaining device for obtaining information corresponding to a function performed on the electronic equipment through said connecting device;
a Braille pattern data generating device for generating Braille pattern data related to the Braille pattern corresponding to the performed function on the basis of the obtained information; and
a controlling device for controlling the emerging state of each of the unit Braille blocks so that the Braille pattern corresponding to the performed function is displayed by said Braille displaying device as at least one portion of the plurality of Braille patterns, on the basis of the generated Braille pattern data.
